(19) United States
(12) Patent Application Publication
(10) Pub. No.: US 2012/0240421 A1
(43) Pub. Date: Sep. 27, 2012

(54) Field Productivity Gauge

(75) Inventor: Stanley R. Clark, Hesston, KS (US)

(73) Assignee: AGCO CORPORATION, Duluth, GA (US)

(21) Appl. No.: 13/337,708

(22) Filed: Dec. 27, 2011

Related U.S. Application Data
(60) Provisional application No. 61/427,558, filed on Dec. 28, 2010.

(51) Int. Cl. G01D 21/00

(52) U.S. Cl. 33/600

(57) ABSTRACT

A field productivity gauge includes an indicator for a present value and an indicator for a comparison value of an operating characteristic, such as field productivity.

### CROSS REFERENCE TO RELATED APPLICATION

Under provisions of 35 U.S.C. §119(e), Applicant claims the benefit of U.S. Provisional Application No. 61/427,558 filed Dec. 28, 2010, which is incorporated herein by reference

### TECHNICAL FIELD

The present invention relates generally to agricultural equipment, and more particularly, to operational indicators, such as gauges, for use with such equipment.

### BACKGROUND

When an agricultural vehicle is used in the field it is common to monitor various operational characteristics of the vehicle and display the present value of such characteristics to the operator using a gauge or other indicator. For example, a vehicle may have a speedometer to indicate the vehicle's ground speed and a fuel gauge to indicate the present fuel level. While these indicators provide information regarding a present value of the monitored operational characteristics to an operator, they do not particularly indicate how well or efficiently the vehicle is performing relative to an expected or desired performance level. In other words, the gauges do not provide an operator with information as to whether the present operating condition is “good” or “bad” with respect to a desired performance level, goal, or waypoint. Thus, even though an operator may know the present value of an operating characteristic, that value provides little context to assist the operator in determining whether the present level of performance is inefficient or suboptimal. Thus, by relying solely on the present value of the operating characteristic, the operator may not know that the present performance of the vehicle is suboptimal relative to historical performance and that corrective action should be taken. For example, the user may be operating in a manner which could be greatly improved by adjusting the header, changing operating technique, etc.

While there are sophisticated agricultural guidance systems that may monitor and manipulate various vehicle parameters to obtain information as to the vehicle's level of performance, such systems tend to be expensive and complicated. Furthermore, such systems are often intended for use by users located remotely away from the operator at a backend or office so that the operator himself may not be provided such information. Furthermore, such systems typically require a telecommunications link to communicate between the vehicle and the back office.

What is needed is an inexpensive system located at an agricultural vehicle that can readily provide an operator with indications as to the operational values of the vehicle in a context that informs the operator as to a present level of performance. This would allow an operator to quickly determine when the performance is subpar and prompt an operator to make adjustments. Furthermore, such a system would provide a user with a quick feedback as to how various adjustments, such as changes in vehicle setup or vehicle operation, affect the vehicle's performance.

### BRIEF DESCRIPTION OF THE DRAWINGS

FIG. 1 shows an example embodiment of an agricultural vehicle having a gauge for indicating a present and comparison value for an operating characteristic.

FIG. 2 shows an example embodiment of a gauge for indicating a present and comparison value for an operating characteristic.

FIG. 3 shows an example embodiment of a field fuel efficiency gauge.

FIG. 4 shows another example embodiment of a field fuel efficiency gauge.

FIG. 5 shows another example embodiment of a field fuel efficiency gauge.

FIG. 6 shows another example embodiment of a field productivity gauge.

FIG. 7 shows another example embodiment of a field productivity gauge.

FIG. 8 shows another example embodiment of a field productivity gauge.

FIG. 9 shows an example system of the invention.

FIG. 10 shows an example embodiment of a user interface for use with the invention.

FIG. 11 shows an example embodiment of data that may be used with the invention.

FIG. 12 shows an example embodiment of a display including field fuel efficiency and field productivity gauges.

FIG. 13 shows a flow diagram of an example method of the invention.

FIG. 14 shows an example method of indicating field fuel efficiency.

FIG. 15 shows an example method of indicating field productivity.

### OVERVIEW

As required, example embodiments of the present invention are disclosed. The various embodiments are meant to be non-limiting examples of various ways of implementing the invention and it will be understood that the invention may be embodied in alternative forms. The present invention will be described more fully hereinafter with reference to the accompanying drawings in which like numerals represent like elements throughout the several figures, and in which exemplary embodiments are shown. The figures are not necessarily to scale and some features may be exaggerated or minimized to show details of particular elements, while related elements may have been eliminated to prevent obscuring novel aspects. The specific structural and functional details disclosed herein should not be interpreted as limiting, but merely as a basis for the claims and as a representative basis for teaching one skilled in the art to variously employ the present invention. For example, while the example embodiments are discussed in the context of agricultural equipment in the form of a self-propelled windrower having a rotary mower header, it will be understood that the present invention is not so limited and that other types of equipment may be used.

Some portions of the detailed description which follows may be presented in terms of procedures, steps, logic blocks, processing, and other symbolic representations of operations on data bits that can be performed on computer memory. Each step may be performed by hardware, software, firmware, or combinations thereof.

In an example embodiment, an apparatus is configured to indicate to an operator of an agricultural vehicle a present value and a comparison value for an operating characteristic of the vehicle. In one example embodiment, the characteristic is field fuel efficiency or field usage per area worked. For example, the present value may be a presently monitored value of fuel usage by a fuel monitoring system and the comparison value may be a determined average fuel usage value over a time. In another example embodiment the operating characteristic is field productivity.

The comparison value of the operating characteristic may be determined in accordance with a predetermined scheme, such as by using values associated with a particular field, operator, or other variable. By indicating both a present value and a comparison value of the operating characteristic to the operator, the operator is provided with an indication of the present level of performance in context with historical performance or some other comparison value. For example, the comparison value may be used as a target, goal, or waypoint value for which the operator is expected to strive or to use as a basis for analyzing present performance. For example, if the present value is less than the comparison value, then the operator may be prompted to take ameliorative steps, such as adjusting various settings of the apparatus to improve the present value.

The indicator to indicate the present and comparison values could take various forms, such as analogue or digital gauges of various shapes and sizes. By way of example and not limitation, round or bar graph analogue gauges or digital numerical gauges could be used. Preferably, the present and comparison values are indicated in close proximity to allow for easier comparison by the operator. Various properties of the gauges could also be manipulated in accordance to the relationship between the present value and the comparison value. For example, an alarm may be provided if the present value is worse than the comparison value. The alarm could take various forms such as changing the present value indicator's color or shape, actuating an audible alarm, etc. depending upon whether the present value is below, at, or above the comparison value in order to give an indication of the present level of performance.

In an example embodiment of a system of the invention, one or more subsystems monitor the present value of an operating characteristic to be indicated. The present values may be stored in memory and provided to a controller. The controller may determine a comparison value for the characteristic. For example, the controller may include a comparison value module (CVM) for determining a comparison value for the operating characteristic. The comparison value may be calculated in accordance with a predetermined scheme. In one example scheme, the comparison value is determined by calculating an average value for the characteristic, such as an average historical fuel usage per area for field fuel efficiency, or an average of acres worked over time for field productivity. The controller may send necessary signals to a gauge to provide indications of the present value and comparison value of the operating characteristic.

In the event a present value of an operating characteristic is not presently determined by a subsystem of the apparatus then the controller may also include a present value module (PVM) to determine a present value of the operating characteristic. For example, the PVM may receive inputs from various subsystems and determine a present value for the characteristic. For example, a PVM may receive fuel usage data from a fuel system and ground speed data from a speed monitoring system. Using this information, along with additional information, such as header width, the PVM may calculate a present value for field productivity (acres worked per hour) or field fuel efficiency (fuel usage per area worked). Similarly, a comparison value module (CVM) may then calculate a comparison value for the operating characteristic. These values may then be communicated to an indicator for display.

Memory may be provided to store additional information for use by the PVM and CVM. For example, the width of a header may be used in calculating the rate of area worked by multiplying the ground speed of the vehicle by the header width. A user interface may also be provided for receiving various inputs from a user. For example, a particular scheme to be used by the controller in determining a present value or comparison value may be input by a user. The controller may also receive various inputs from other subsystems such as a location data from a location detection system for associating the vehicle performance with particular locations or fields. A database may be used to associate the various characteristics, such as operator, field worked, time worked, vehicle id, etc. for use in determining the various comparison values. The entire system may be located at the vehicle to allow the operator access to the information without the need of a telecommunications system or communication with a back off or other remote functions.

### DETAILED DESCRIPTION

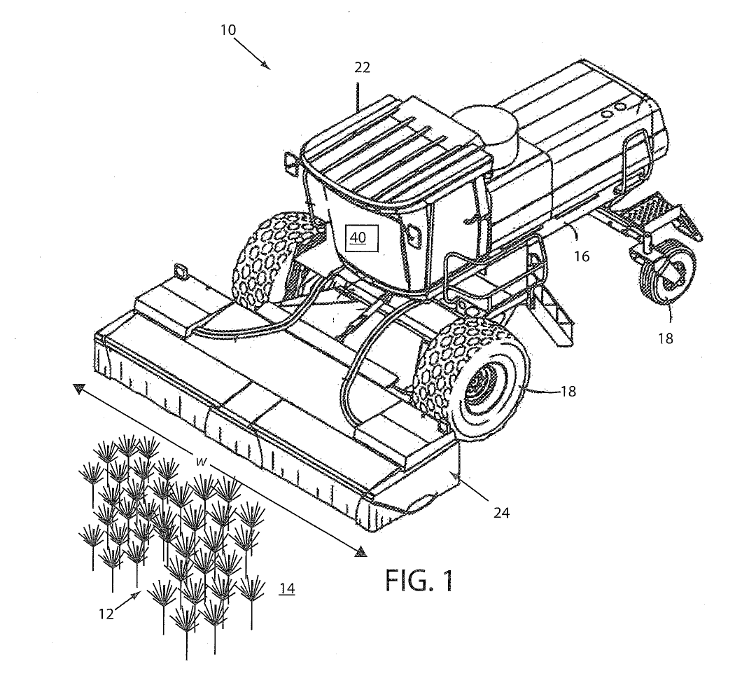

Turning to the Figures, FIG. 1 shows an agricultural apparatus 10 in the form of a self-propelled windrower operable to process crop material 12, such as, cutting and collecting standing crop 12 in a field 14, conditioning the cut material, and discharging the conditioned material into a windrow or swath. The windrower 10 may be arranged as known to one of skill in the art and include a chassis or frame 16 supported by wheels 18 for movement across a field 14 to be harvested. The frame 16 may carry a cab 22, within which an operator controls operation of the apparatus 10.

A harvesting header 24 may be supported on the front of the frame 16 and be configured to process crop material 12. The header 24 may have a width w that defines the width of operation of the apparatus 10. By way of example and not limitation, the header 24 may have a width of 16 feet such that as the apparatus 10 moves through the field 14 a sixteen foot wide path is worked. A display or gauge 30 may be provided within the cab 22 of the apparatus 10 to provide the operator with useful information about the operation of the vehicle, including a present value of an operating characteristic and a comparison value for the operating characteristic.

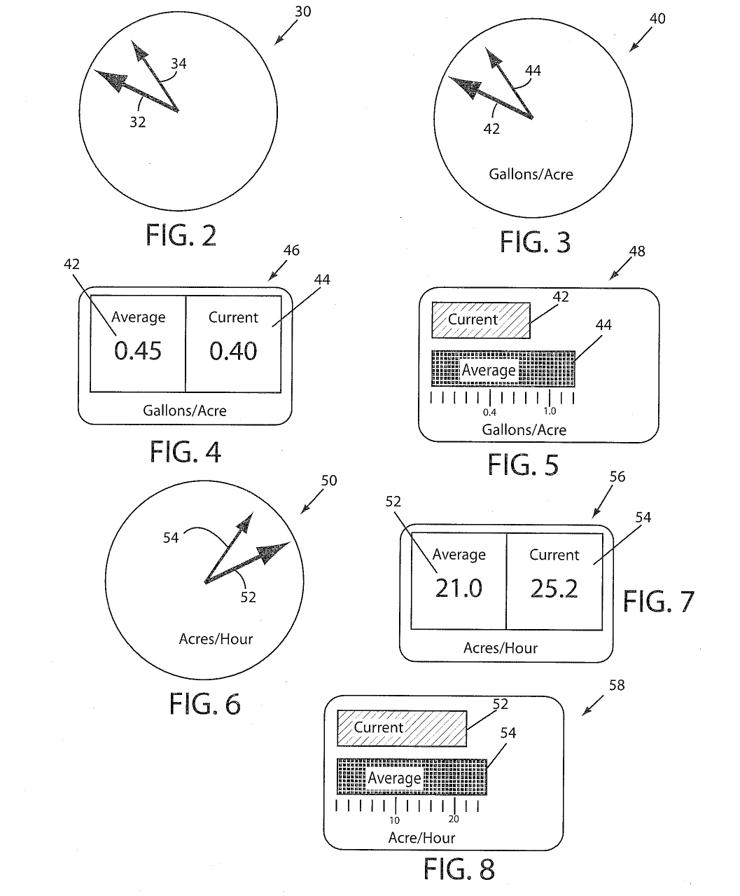

As seen in FIG. 2, in one example embodiment, the gauge 30 is in the form of a round analog gauge having a first indicator 32 configured to indicate a present value for an operating characteristic of the equipment and a second indicator 34 configured to indicate a comparison value for that characteristic. As discussed in more detail below, different operating characteristics may be indicated, such as field fuel efficiency and field productivity.

The present operating value can be computed and continually updated to show the present operating status of the equipment. The comparison value for a particular operating characteristic may be determined in accordance with a predetermined scheme. Thus, the comparison value may be different depending upon the particular scheme used. For example, one scheme may determine a comparison value as an average of previous values, a median of previous values, the highest previous value, or a statistical deviation of previous values, etc. Data values for an operating characteristic of the vehicle may be recorded and used by the scheme for determining the comparison value. For example, data may be stored in memory and then retrieved to compute a comparison value, such as an average value for that characteristic over time. A comparison value could also be input by an operator. For example, as discussed below, a comparison value may be input a user to encourage the operator to strive for that value.

Different data could be employed to determine the comparison value. For example, recorded values could be associated with particular criteria, such as time worked, operator id, the field worked, etc. This data could be stored in a database or other means and retrieved for use by the particular scheme employed to determine the comparison value. In determining the comparison value, the particular scheme used may use data that meets predetermined criteria. For example, data associated with a particular field, operator, crop, time of year, etc. may be used in determining a comparison value. The comparison value could also change over time as the vehicle ages, more fields are worked, etc., and additional data is collected and may vary depending upon the particular scheme employed.

FIG. 3, show an example embodiment of a field fuel efficiency gauge 40 that indicates fuel usage per area worked by the machine and includes a present field fuel efficiency indicator 42 and a comparison field fuel efficiency indicator 44. The field fuel efficiency gauge 40 indicates data in gallons per acre but different fuel units and area units could be used and the relationship could be indicated as area per fuel, if desired. For example, acres/liters could be used. Furthermore, whereas the field fuel efficiency gauge 40 in FIG. 3 is shown as a round analogue gauge, other type gauges or displays could be used. For example, FIG. 4 shows an example embodiment of a field fuel efficiency gauge 46 in digital form, and FIG. 5 shows a field fuel efficiency gauge 48 in bar graph form. Other embodiments will become apparent to one of ordinary skill in the art.

In the example embodiment shown in FIG. 3, the comparison value 42 indicated on the field fuel efficiency gauge 40 may be determined using historical fuel usage data. For example, data on previous fuel usage and area worked may be stored in memory. The scheme to determine the comparison field fuel efficiency value may determine an average value of fuel usage over the historical area worked by the apparatus. This value may be calculated by retrieving data on the historical area worked by the machine and historical area worked. To determine the size of the area worked, the distance traveled by the apparatus 10 could be multiplied by the width of the header. Or, if desired, only data that fits specific criteria of the scheme may be used, such as data that corresponds to the characteristics of the present work, such as the field to be worked, the present operator, the crop to be harvested, etc. The engine control unit (ECU) may provide this information to a controller for determining the present and comparison values.

FIGS. 6-8 show example embodiments of a field productivity gauge that indicates a present field productivity value 52 and a comparison field productivity value 54 shown in area worked over time and include an analog gauge 50 (FIG. 6), a digital numerical gauge 56 (FIG. 7), and a bar graph gauge 58 (FIG. 8). To determine a present field productivity value, input from other systems of the vehicle may be used, such as the travel speed of the apparatus and the width w of the header. For example, if the apparatus is moving at 10 feet per second and the predetermined header width w is 16 feet then 160 square feet of area per second is being worked and the apparatus is running at a field productivity rate of about 13 acres per hour. Under one scheme, a comparison value of field productivity may be determined by dividing the historical area worked by the apparatus 10 by the time spent in working mode. This data may be stored at the vehicle. As mentioned above, a comparison value may employ data for a particular field, operator, crop, etc. depending upon the particular scheme used.

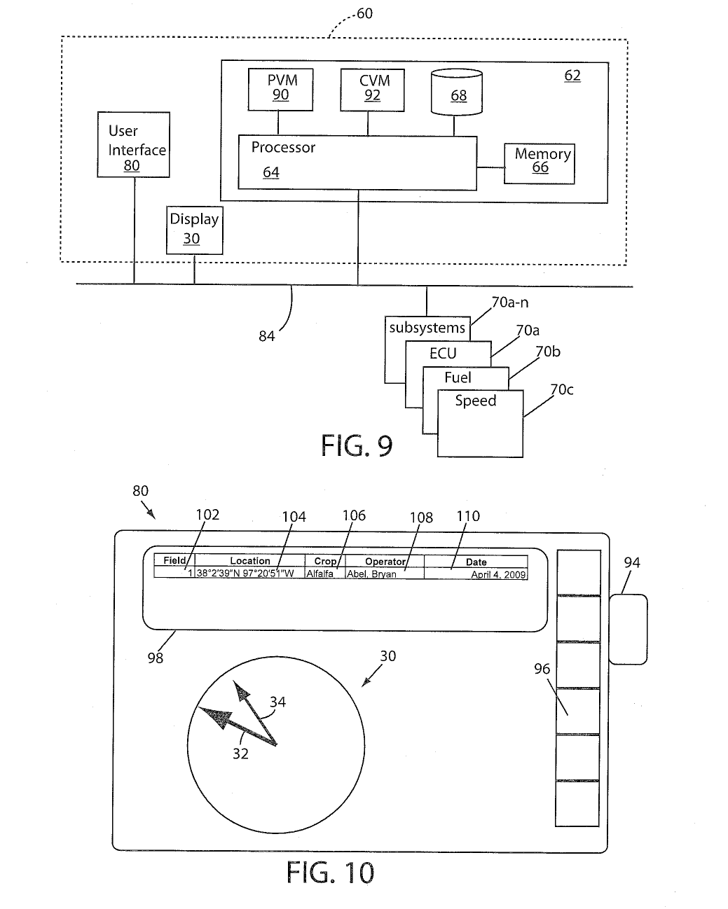

FIG. 9 shows an example field gauge system 70 and its operational environment that includes a display 30 for displaying a present and comparison value for an operating characteristic, such as a field fuel efficiency or field productivity. A controller 62 is provided that is in communication with the gauge 30 and operable to send signals to the gauge 30 so that the gauge correctly displays a present and comparison value for the operating characteristic. The controller 62 may be hardware, software, firmware or a combination thereof and configured to communicate the various subsystems and components to indicate a present and comparison value for an operating characteristic.

The controller 62 may include a processor 64 to execute operation, and a memory 66 that are coupled to the processor 64 and configured to store values for the operating characteristic and other data associated therewith. For example, the width w of the header, the schemes for determining a present value and/or comparison value, the operator associated with work performed, the location of field, etc. may be stored at the memory 74. A database 68 may store associated data for use in determining a comparison value. The controller 62 may communicate with various components and subsystems 70a-n over a communications bus 84, such as a Communication Area Network (CAN) bus protocol that is frequently employed in agricultural equipment and known to one of ordinary skill in the art.

One or more vehicle subsystems 70a-n may monitor various operations of the vehicle and provide operational values to the controller 62. A user interface 80 (FIG. 10) may be provided to allow an operator to communicate with the controller 62, such as by inputting a desired value or selecting a desired scheme. The user interface 80 may take various forms, but in the example the interface 80 includes a display 98 for displaying information to an operator and various input keys 96 and an input knob 94 to allow a user to interact with the interface.

The present value of an operating characteristic to be indicated may be determined by a subsystem of the apparatus 10 and provided to the controller 62. For example, an engine control unit (ECU) may calculate a present value for a particular operating characteristic. In order to determine a present value in situations where it is not determined by a subsystem 70, the controller 62 may also include a present value module (PVM) 90 for calculating the present value of an operating characteristic. For example, the PVM 90 may receive fuel usage data from a fuel system 70b and ground speed data from a speed monitoring system 70c. The PVM 90 may retrieve header width information stored in the memory 66. The PVM 90 may use this information to calculate present values for fuel usage per area and provide the information to the processor 64. This information may also be recorded at the memory 66 and used in determining a comparison value. These present values may then be communicated by the processor to the display 30 for displaying to the operator.

To determine a comparison value for the operating characteristic, the controller 62 may include a Comparison Value Module (CVM) 92. Like the PVM, the CVM may be hardware, software, or firmware. Although the PVM and CVM are shown separately for purposes of discussion, they could be part of the processor 64. The CVM 92 may determine a comparison value in accordance with a predetermined scheme. For example, the CVM 92 may include instructions to determine a comparison value for field fuel efficiency as the average fuel efficiency over the life of the apparatus in gallons per acre. The determined comparison value may be sent from the CVM 92 to the processor 64. The processor 64 can then use the comparison value and a predetermined scheme to determine what signals to send to the display 30. For example, the processor 64 may perform a comparison between the present value and the comparison value and change characteristics of the indicator on the display 30, such as showing the present value in red if it is less than the comparison value.

In one example of operation of the PVM 90, the ground speed of the apparatus 10 is measured by a speed monitor system 70c and fuel consumption is monitored by a fuel monitor system 70b. This information can then be sent to the PVM 90 which may compute the current fuel efficiency and record corresponding data in the memory 66. The present operating value of the fuel efficiency may be sent to the processor 64 which sends a corresponding signal to the display 30 to indicate the present operating value. The CVM 92 may retrieve data stored in the memory 66 to compute the average fuel efficiency of the equipment in accordance with a predetermined scheme. For example, the CVM 92 may retrieve fuel efficiency data that is associated with the field 14 currently being worked by the equipment that may be stored in the database 68. Or, the CVM 92 could retrieve information from a specified time period, such as the previous week's information to compute an average value.

The user interface 80 may be used to select a particular scheme for calculating the comparison value or to provide a specified comparison value. For example, an operator may elect to input a comparison value a 0.5 gallons per acre or 2 acres/gallon to serve as a goal for field fuel efficiency. The recorded data could include additional information such as the identity of the operator, the location of the field, etc. that may be associated in the database 68. The CVM 92 could then use this information to provide a comparison value for a particular operator, field, etc. depending upon the particular scheme employed.

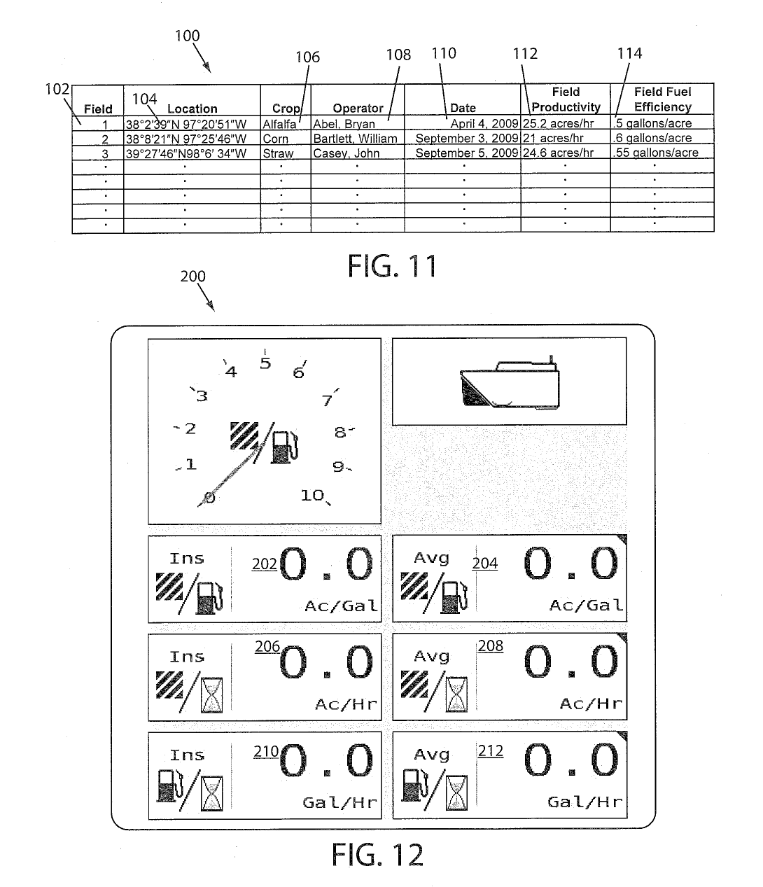

As shown in FIG. 10, the user interface 80, may also allow a user to input identity data for the present work to be performed such as inputting the field identification 102, field location 104, crop to be worked 106, the operator identity 108, the date 110, etc. This information may be associated and stored in the database 68 as shown in the table 180 in FIG. 11. When the apparatus 10 is again in that field, the previous data could be retrieved and used in determining a comparison value. This could be done manually by the operator using the user interface 80 or automatically by the controller 62. For example, values may be used that are associated with a particular location, such as a GPS coordinate such that the comparison value is automatically retrieved when the vehicle is again at that location. For example, the controller may receive data from an LDS, such as a GPS system, and associate that location with the fuel consumption value. When the vehicle is again at that location as indicated by the LDS then the comparison value could be automatically retrieved. Similarly, data associated with a particular time, crop, operator, etc. could be used in determining a comparison value.

FIG. 11 shows an example embodiment of a table 100 that may be used to for the various data. This data may be stored in the database 68 and used to retrieve data that is relevant in determining a comparison value. In this example embodiment the table 100 includes field 102, location 104, crop 106, operator 108, date 110 values for previous work performed, as well as the resulting filed productivity 112 and field fuel efficiency values 114.

In the example embodiment shown in FIG. 12, a display 200 that includes indicators for multiple operating characteristics with present and comparison values. This allows an operator to govern his activity in accordance with a selected operating characteristic. For example, a first operating characteristic of field fuel efficiency is shown in gauge 202 which indicates a present value for field fuel efficiency in acres worked per gallon consumed and gauge 204 displays a comparison field fuel efficiency value which is an average value.

Likewise, field productivity is indicated in a present value at gauge 206 and a comparison value at gauge 208 in acres worked per hour. Present and comparison values for fuel efficiency over time, shown in liters per hour, is indicated by gauges 210-212. Thus, the gauges 202-212 indicate in close proximity to one another both present and comparison values for an operating characteristic. It should be noted that different operating characteristics may be somewhat inapposite with each other in that the more acres worked per hour (higher field productivity) may lead to more gallons of fuel consumed per acre (lower field efficiency). For example, a fleet operator under a time deadline may prefer that an operator maximize field productivity, whereas a const-conscious operator may be more concerned with field fuel efficiency. Thus, an operator may be instructed as to which operating characteristic he should strive toward.

By indicating both the comparison value and the present operational value an operator of the apparatus, an operator can quickly determine whether the apparatus is operating at a desired level and if not, to take appropriate action. For example, if there is an indication that the present field fuel efficiency of field productivity is below the comparison value, an operator may make an adjustment to the equipment, such as raising or lowering the header. This, thereby provides and convenient means to determine whether the operation of the vehicle is acceptable. To further assist the operator, various alerts may be used. For example, if the present operational value of the parameter is lower than the comparison value then the indicator of the present value may change color, shape, and/or size, blink, etc. In one example embodiment the present value indicator changes color between green and red as the operating value meets or falls below the comparison value.

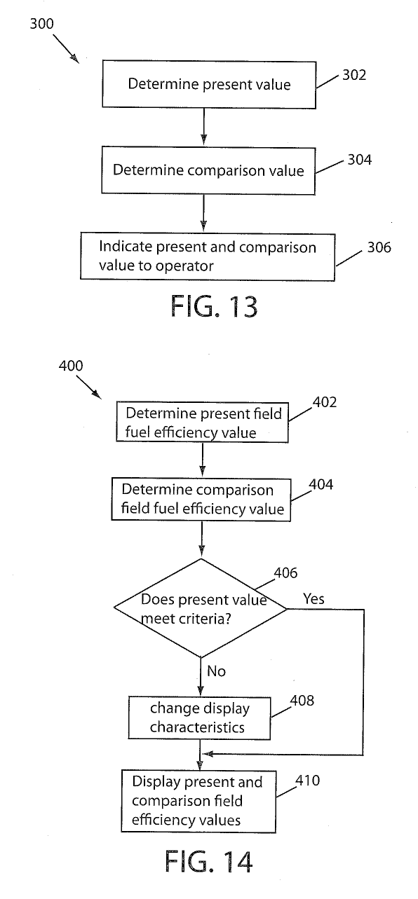

FIG. 13 shows an example method 300 of the invention. At block 302 a present value of an operating characteristic is determined. At block 304 a comparison value of the operating characteristic is determined and at block 306 both the present and the comparison value of the operating characteristic are indicated to an operator.

FIG. 14 shows an example embodiment of a method for indicating field fuel efficiency to an operator. At block 402 a present value of field fuel efficiency is determined. For example the rate of fuel being consumed by the apparatus 10 may be retrieved from a fuel subsystem of the apparatus. The rate of area worked may be determined using the speed of the apparatus and the width of the header. This information may then be used by the PVM 90 to determine a present value for acres worked per gallon.

At block 404 a comparison field fuel efficiency value may be determined. For example, the CVM 92 may retrieve historical data to determine the amount of fuel consumed by the apparatus 10 and the area worked to determine the area worked per gallon of fuel. The data used in determining the CVM may vary depending upon the particular scheme used. For example, in one embodiment only data associated with the same field currently being worked is used.

At block 406 an analysis may be performed using the present and comparison values. For example, the processor 64 may determine whether the present value of the field fuel efficiency is within an acceptable range, such as within 5% of the comparison value. If not, the processor may change the characteristics of the display. For example, the present value may change color, shape, size, brightness, may blink, or otherwise indicate to the operator that the present value is unacceptable. An audible alarm or other alert may also be provided.

At block 410 the present and comparison field fuel efficiency values are indicated to the operator, such as on the display 30. The particular characteristics of the display may vary depending upon the particular present and comparison values and the scheme employed by the processor 64.

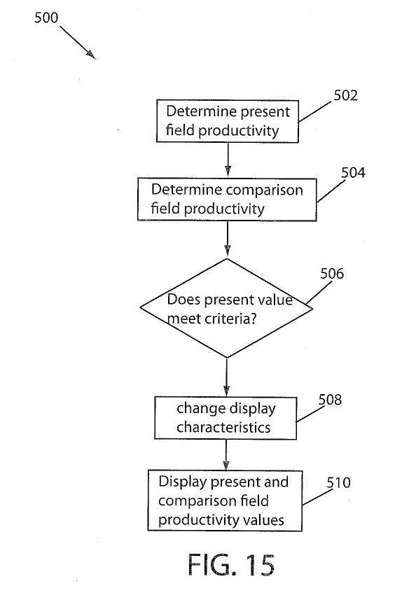

FIG. 15 shows an example embodiment of indicating field productivity to an operator. At block 502 a present value of field productivity is determined. For example, the PVM 90 may receive a value for ground speed from a subsystem 70c of the apparatus and retrieve the header width w from the memory 66 to determine the area worked per hour. At block 504 a comparison field productivity value may be determined. For example, the CVM 92 may retrieve historical data to determine the area worked and the time the apparatus was worked to determine an average of acres worked per hour as a comparison value. At block 506 an analysis may be performed using the present and comparison field productivity values. For example, the processor 64 may determine whether the present value of the field productivity is within an acceptable range of the comparison value. If not, the processor may change the characteristics of the display at block 508. For example, the present value may change color, shape, size, brightness, may blink, or otherwise be manipulated to indicate to the operator that the present value is unacceptable. An audible alarm or other alert may also be provided.

At block 510 the present and comparison field productivity values are indicated to the operator, such as on the display 30. The process may continue to give the operator a real time indication of how well the apparatus is performing and an increased ability to determine whether an adjustment should be made.

While in the example embodiment the agricultural vehicle was in the form of a windrower other agricultural equipment could be used, such as combines, tractors, etc. Thus, while the present invention has been described herein with reference to particular embodiments thereof, latitude of modifications, various changes and substitutions is intended in the foregoing descriptions. It is understood that the invention is not to be limited to the particular terms used in the following claims, but that the invention will include any and all embodiments and equivalents falling within the scope of the appended claims.

What is claimed is:

1. A field productivity gauge, comprising:
a first indicator configured to indicate a present value of field productivity of an agricultural vehicle; and
a second indicator configured to indicate a comparison value of field productivity of the agricultural vehicle.

2. The field productivity gauge of claim 1, wherein the first indicator and the second indicator are proximate one another.

3. The field productivity gauge of claim 1, wherein the first indicator is configured to change a display property in response to the present value and the comparison value.

4. The field productivity gauge of claim 3, wherein the display property is color.

5. The field productivity gauge of claim 1, wherein the first indicator and second indicator are provided in a cab of the agricultural vehicle.

6. The field productivity gauge of claim 1, wherein the first indicator and the second indicator are configured to indicate the present and comparison value simultaneously.

7. A method comprising:
indicating at an agricultural vehicle a present value of field productivity; and
indicating at the agricultural vehicle a comparison value of field productivity.

8. The method of claim 7 further comprising, determining the comparison value at the agricultural vehicle.

9. The method of claim 8 wherein the step of determining a field productivity comparison value comprises:
determining an area worked by the vehicle;
determining the time used to accomplish for the area; and
dividing the area worked by the time used.

10. The method of claim 9, wherein the step of determining an area worked by the vehicle comprises:
determining a distance traveled by the vehicle; and
multiplying the width of a header of the vehicle by the traveled distance.

11. The method of claim 8, wherein said step of determining the comparison value of the operating characteristic at the agricultural vehicle comprises determining a comparison value of the operating characteristic associated with a predetermined identifier.

12. The method of claim 11, wherein the predetermined identifier is a field identity.

13. The method of claim 11, wherein the predetermined identifier is an operator identity.

14. The method of claim 11, wherein the predetermined identifier is a time period.

15. An agricultural gauge constructed and arranged substantially as hereinbefore described with reference to, and as shown in the accompanying figures.
